(19) United States
(12) Patent Application Publication
(10) Pub. No.: US 2008/0276565 A1
(43) Pub. Date: Nov. 13, 2008

(54) METHOD AND APPARATUS FOR STICK BUILDING HOMES WITHIN A FACTORY

(75) Inventors: James Rhodes, Las Vegas, NV (US); Matthew Priddy, Las Vegas, NV (US)

Correspondence Address: BELL, BOYD, & LLOYD LLP, P.O. BOX 1135, CHICAGO, IL, 60690, US

(73) Assignee: Rhodes Design and Development Corporation, Las Vegas, NV (US)

(21) Appl. No.: 11/745,160

(22) Filed: May 7, 2007

(51) Int. Cl. A01G 9/02; E04B 1/00; E04G 21/00

(52) U.S. Cl. 52/745.01; 47/65.9; 52/745.02

(57) ABSTRACT

A method and apparatus for stick-building large buildings (e.g., single-family homes, townhouses, apartment complexes, commercial structures, multi-story buildings, buildings legally or physically too large or oddly shaped to be transported substantially intact via public roads, etc.) within a factory is presented. The factory can be constructed on or near the intended building destination(s). The factory can include a large enclosed structure that shelters the construction process, the raw materials and/or workers from the extremes or effects of the natural elements. Inside the factory, one or more buildings are constructed using stick-building construction techniques (e.g., constructing the building from raw materials without pre-manufactured panels or modular sections). The factory can use assembly line and/or assembly point stick-building techniques.

### RELATED APPLICATIONS

This application is related to co-pending U.S. patent application Ser. No. 11/431,196 entitled “Building Transport Device” and filed on May 9, 2006; Ser. No. 11/620,103 entitled “Device and Method for Transporting a Load” and filed on Jan. 5, 2007; Ser. No. 11/559,229 entitled “Transport Device Capable of Adjustment to Maintain Load Planarity” and filed on Nov. 13, 2006; Ser. No. 11/620,560 entitled “Method and Apparatus for Mobile Stem Wall” and filed on Jan. 5, 2007; and U.S. Provisional Patent Application Ser. No. 60/887,696, entitled “METHOD AND APPARATUS FOR INTEGRATED INVENTORY AND PLANNING” and filed on Feb. 1, 2007 the entire contents of each of which is hereby incorporated by reference.

### BACKGROUND

Typically, large buildings (e.g., single-family homes, townhouses, apartment complexes, commercial structures, multi-story buildings, buildings legally or physically too large to be transported substantially intact via public roads, etc.) are built upon their permanent locations. A foundation is prepared, and raw materials and perhaps small components (e.g., pre-formed roof or floor trusses, door frames, window frames, etc.) are brought to the site and assembled piece by piece onto the foundation to form the building. However, such a stick-building arrangement is inefficient for many purposes. For example, if many large buildings are to be built as part of a development, workers and materials would need to be moved to many different locations which may be far from each other. Further, temperature, wind, precipitation, insect infestations and other weather or environmental issues can cause delays in production or damage to partly completed buildings.

### SUMMARY

In one embodiment, a method and apparatus for stick-building large buildings (e.g., single-family homes, townhouses, apartment complexes, commercial structures, multi-story buildings, buildings legally or physically too large or oddly shaped to be transported substantially intact via public roads, etc.) within a factory is presented. The factory can be constructed on or near the intended building destination(s). The factory can include a large enclosed structure that shelters the construction process, the raw materials and/or workers from the extremes or effects of the natural elements. Inside the factory, one or more buildings are constructed using stick-building construction techniques (e.g., constructing the building from raw materials without pre-manufactured panels or modular sections). The factory can have one or more areas to store raw materials, and the factory can also have one or more areas in which buildings are partly or entirely constructed. In one embodiment, the building is substantially completed within the factory, including the interior and exterior building elements (e.g., drywall, electrical and mechanical systems, bricks, vinyl siding, etc.). The building is delivered from the factory to an installation site using a specialized transport device or any other suitable device once substantially completed. The building is then preferably fixed to the site according to the appropriate local building codes or HUD regulations.

As part of the construction process, appropriate raw materials are selected from storage and moved from storage to a construction area where the raw materials are transformed into portions of a building (e.g., a floor, walls, plumbing, wiring, etc.). In one embodiment, the substantially sequential process of constructing a building is similar to the process for stick-building a building directly on a building site. Thus, the construction process follows a substantially bottom to top flow. The construction workers first construct the floor or foundation frame. The construction workers then frame the rest of the building (e.g., frame the first floor first, then frame the second floor, then additional floors or the roof or any other suitable framing ordering). The remaining interior and exterior construction processes can be conducted in parallel in any appropriate manner, or, alternatively, in serial or any other suitable ordering. Additionally, the building may be substantially finished within or near the factory. The level of interior and exterior finishing will depend on the ultimate design specifications.

Once the building is substantially complete, the building is transported from the factory to the building destination. The transport device may include a specially designed transportation vehicle that can flexibly accommodate buildings of various sizes and can maneuver the completed building to the destination. Additionally, the transport device may include existing vehicles that have been proven to move existing buildings between two remote locations. The transportation is preferably direct; however, the building can be stored temporarily at one or more locations during the process of moving it from the factory to the building site. Once the completed building is situated at the destination, the complete building is connected to the desired public utilities (e.g. electric, water & sewage, gas, etc.), or any suitable alternatives (e.g., wells, septic systems, private energy sources, etc.).

In one embodiment, raw building materials are brought to the factory and stored in sufficient quantities to sustain an uninterrupted construction process. In another embodiment, an automatic planning and inventory system (such as any described in U.S. Provisional Patent Application Ser. No. 60/887,696, entitled “METHOD AND APPARATUS FOR INTEGRATED INVENTORY AND PLANNING” and filed on Feb. 1, 2007 or any other suitable planning system) helps provide an efficient stream of raw materials and/or minor components. Construction workers may use material handling devices (e.g., fork lifts, cranes, dollies, robotics, rail systems, conveyor systems, or any other suitable devices) to move and transport raw materials within the factory. As a result, in one embodiment, construction workers can quickly, safely and easily move large and ungainly raw materials to and from desired locations within the factory. As a result, raw materials can be arranged and stored in one or more locations and in any suitable manner.

In one embodiment, the factory is laid out such that the stick-built construction process is an assembly point process. In the assembly point process, workers and raw materials converge on one or more construction locations within the factory. The building is statically located in one of the construction locations during substantially its entire construction process. The building does not move until the building is substantially complete according to the design specifications.

In an alternative embodiment, an assembly line process is used for the stick-built construction process. Raw materials are brought to the assembly line at predetermined points or stations to be incorporated into the building. Preferably, the raw materials are arranged along the assembly line according to a predetermined construction process; however, the raw materials can be arranged in any suitable manner. Instead of remaining static, the building moves as it is built from one raw material point to the next according to the predetermined construction process. In one embodiment, the building stops at one or more locations at which raw materials or minor components are incorporated into the building (e.g., at one location all the exterior walls are framed); however, in various other embodiments, raw materials or minor components are incorporated into the building as the building moves along the assembly line. It should be noted that the term assembly line also includes a plurality of assembly paths. For example, one building may move through a different path or visit different stations than another building produced by the same assembly line. Thus, an assembly line can include more than one paths through which buildings progress as they are built.

In another alternative embodiment, the assembly point and assembly line process can be combined such that the building moves between fewer assembly points, which is then serviced by multiple raw material points similar to the assembly point process.

Additional features and advantages are described herein, and will be apparent from, the following Detailed Description and the figures.

### BRIEF DESCRIPTION OF THE FIGURES

FIG. 1 is a manufacturing facility in which large buildings are stick-built using an assembly point technique in accordance with one embodiment.

FIG. 2 is a manufacturing facility in which large buildings are stick-built using an assembly line technique in accordance with one embodiment.

### DETAILED DESCRIPTION

In one embodiment, a factory in which buildings (e.g., single-family homes, townhouses, apartment complexes, commercial structures, etc.) are stick-built is provided. The factory stick-built process is preferably substantially linear and sequential, like the traditional onsite stick-building method; however, the factory stick-built process can have any suitable traits.

Stick-Building in a Factory

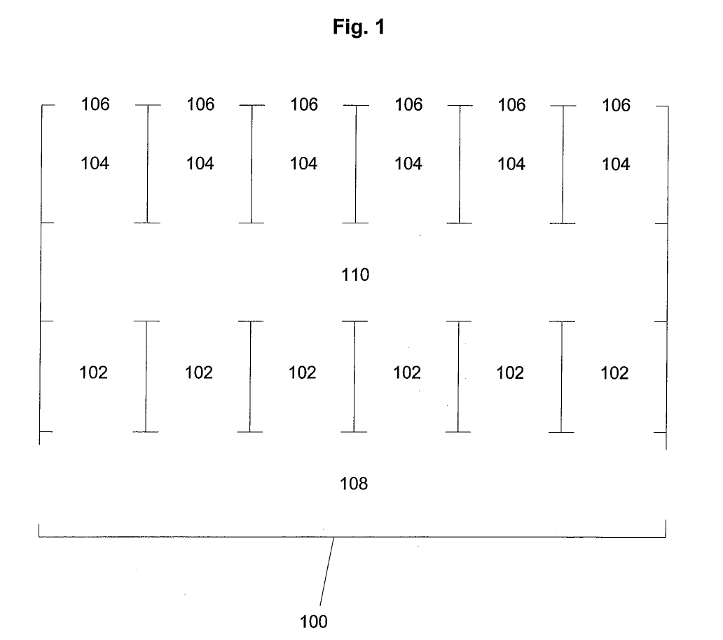

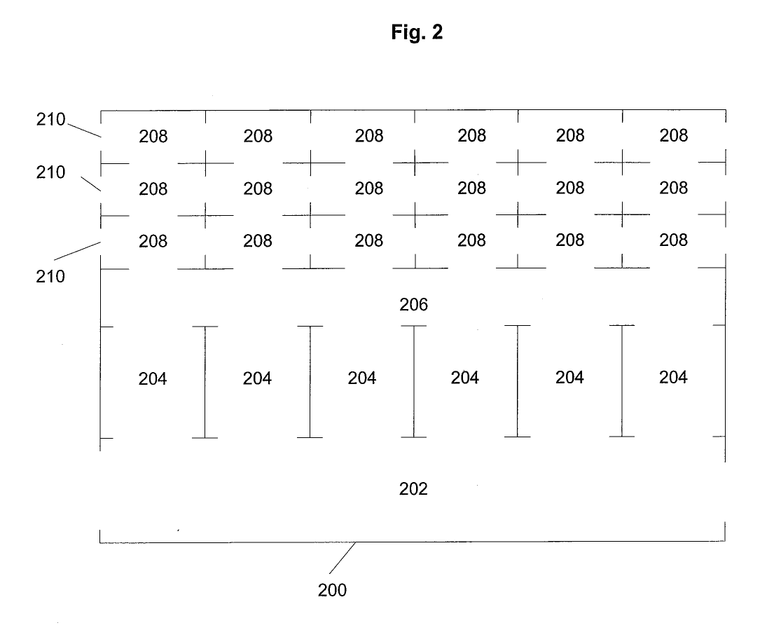

FIGS. 1-2 show building manufacturing facilities of various embodiments. Preferably, a building factory system includes at least one enclosed building 100; however, an enclosed building is not required. Preferably the enclosed building 100 includes environmental controls; however, environmental controls are not required. The enclosed building 100 can include or be made or formed from any suitable building materials such as metal, wood, fabric, plastic or any other suitable material or combination of materials. Preferably, the enclosed building 100 protects the workers, supplies, partially completed buildings and any other objects located inside the facility from any one or more of the sun, wind, precipitation, or other environmental elements, theft and/or any other undesirable consequences; however, the enclosed facility is not required to provide such protection. The enclosed building 100 preferably includes one or more areas to construct a building 104, one or more raw material storage areas 102, equipment to assist moving raw materials within the factory, and equipment to move the complete or incomplete building; however the enclosed facility 100 can have any suitable materials, areas and configuration.

Preferably, the system includes one or more materials storage areas 102 within the building 100 in which raw materials and minor components are stored so that they are available for integration into a building when needed; however, such storage areas 102 can be located outside or can be absent. The stick-built construction process in the system preferably begins the assembly of raw materials and/or minor components (e.g., floor trusses, roof trusses, door frames, window frames, etc.) with the floor or foundation frame (hereafter floor frame); however, the process can begin assembly with any suitable portion of the building to be built. Raw materials used to construct the floor frame are selected and brought from the storage area 102 to a construction assembly location 104. Preferably, there are a plurality of construction assembly locations 104; however the system is not required to have a plurality of construction assembly locations 104. Further, the layout of storage areas 102 and construction assembly locations 104 is preferably designed to increase the efficiency of stick-building buildings; however the layout can be any suitable layout. Further, it should be noted that certain raw materials or minor components may be found in one or more storage areas 102 but not other storage areas 102. For example, one storage area 102 may be devoted to a particular raw material or minor components (e.g., lumbar, fixtures, carpet, etc.) or a reduced selection of raw materials or minor components. Alternatively, one or more storage areas 102 may store a many or all of the raw materials to be used in assembling a building.

In one embodiment, the floor frame raw materials are cut, if necessary, and assembled according to a predetermined design. Preferably, at least one of the construction assembly locations 104 is operable to produce more than one design of building; however, such versatility is not required. In a typical building, the floor frame is formed by creating floor trusses that are secured together and a decking material.

Preferably, after the floor frame is complete, the structural and nonstructural wall frames of the first level are constructed, however assembly of the building can take place in any suitable order. Raw materials for the wall frame are selected and brought from the storage area 102 to the construction assembly location 104. The raw materials for the wall frame are cut, if necessary, and assembled and integrated with the floor frame according to the predetermined plan. The wall frame is typically assembled in sections according to a predetermined standard or the carpenter's preference. The framing process also preferably takes into account future window and door openings. In one embodiment, after a section of wall frame is completed, the section is raised and attached to the floor frame and any existing section of the wall frame. In another embodiment, sections of wall frame are integrated with the floor frame as they are assembled.

In one embodiment, if the building design includes an additional building level, the raw materials for a floor frame are again selected and brought from the storage area 102 to the construction assembly location 104. The second floor frame raw materials are cut, if necessary, assembled and integrated into the building on top of the existing first floor wall frame. Subsequently, the raw materials for the second floor wall frame are selected and brought from the storage area 102 to the construction assembly location 104. As with the first floor, the raw materials for the second floor wall frame are cut, if necessary, and assembled in sections. In one embodiment, when a section of the second floor wall frame is completed, the section is raised and integrated with the second floor frame and any existing section of the second floor wall frame. In another embodiment, the section is integrated into the building while the section is assembled. In various embodiments, this process can continue according the number of floors required in the building's design. Preferably, once the final level is framed, the roof trusses are cut, if necessary, and assembled/integrated into the building at the top of the final wall frame level; however the roof of the building can be integrated in any suitable manner.

In one embodiment, after the initial framing work is complete, the construction process remains linear and sequential with one process completed at a time. In another embodiment, the construction process continues with more than one construction process occurring simultaneously (e.g., processes can be performed logically and efficiently together are performed together).

In one embodiment, once the initial framing is complete, the exterior raw materials are selected and brought from one of the storage areas 102 to the construction assembly location 104. Due to the wide variety of exterior material, the subsequent assembly process can be material dependent (e.g., brick or vinyl siding). In one embodiment where the framing material is wood, plywood sheathing is attached to the exterior of the building frame. Following the plywood sheathing, a weather barrier housing wrap can be attached to the plywood sheathing; however such a wrap is not required. Depending on the regional insulation requirements or any other suitable factors, exterior foam insulation may be attached to the weather barrier housing wrap or any other suitable portion of the building. Typically, the next layer of material depends on the design requirements. In one embodiment, vinyl siding is attached as the final layer around the entire building. Alternatively, the building design may require that a brick or stone facade is attached as the final building exterior. In another embodiment, a combination of different siding raw materials can be combined to form the building's exterior (e.g. a combination of any known siding element such as brick, vinyl, aluminum, wood, stone, etc.). In one embodiment, the windows and doors can be installed after the exterior facade is completed. In other embodiments, the windows and doors can be installed either simultaneously with the other exterior materials or before the other exterior materials.

In one embodiment, following the exterior construction process, the interior construction process begins; however, in various other embodiments, the interior construction process begins before or during the exterior construction process. Raw materials for the electrical (e.g. power, communication wiring, receptacles etc.) and mechanical systems (e.g. plumbing, HVAC duct work, etc.) are selected and brought from one of the storage areas 102 to the construction assembly location 104. The framing materials can be prepared to receive the electrical and mechanical systems after they are assembled, while they are assembled or in any other suitable manner. In one embodiment, holes are drilled in the wall and floor frames or additional framing supports are constructed to accommodate the electrical and mechanical systems. As described above, because the electrical and mechanical material installation are not dependent on the exterior materials construction process, the electrical and mechanical materials can be installed before, during, or after the exterior materials are installed.

In one embodiment, after the electrical and mechanical systems are in place, the interior wall frames are insulated and/or covered; however, the interior wall frames can be insulates and/or covered in any suitable manner or left without insulation and/or uncovered. Raw materials for the interior walls are selected and brought from one of the storage areas 102 to the construction assembly location 104. In one embodiment, the insulation is installed before the interior wall covering is installed. Insulation can be fiberglass bats, rigid foam, or any other suitable insulation material. The installed wall material covering can be drywall suitable for the interior location, wood, tile, or any other suitable material. In another embodiment, the interior wall material covering can be any combination of suitable materials such as wood, drywall, and tile. In yet another alternative embodiment, the wall covering material can be installed before the insulation. However, where the insulation is installed after the wall covering material, the insulation is preferably suitable to be blown into the walls, such as cellulose insulation or any other suitable alternative or there; however, the insulation can be any suitable material that is introduced into the frame in any suitable manner. Once the interior walls are covered, the walls can be further finished with paint, wall paper, carpet or any other suitable decorative and/or protective covering according to the design specification.

In one embodiment, after the interior walls are completed, floor covering are installed; however, the floor coverings can be installed at any suitable time including before or parallel with completion of the interior walls. Raw materials for the flooring (e.g., wood flooring, tile, carpeting, or any other suitable materials) are selected and brought from one of the storage areas 102 to the construction assembly location 104. Preferably before the flooring material is installed or as part of the installation, any necessary floor preparation is performed; however, floor preparation is not required. Additional sound dampening mats, self-leveling compounds, or any other appropriate preparatory material may be installed to insure proper floor installation. In one embodiment, after the preparatory work is complete, the floor covering is installed; however the floor covering can be installed in any suitable manner or not at all. In one embodiment, wood flooring is nailed, adhered or otherwise affixed to the floor in any suitable manner. It should be understood that in various embodiments, different types of floor or wall coverings can be installed in different areas of the building (including different areas of one room). Thus, carpet can be installed in one bedroom, while wood floors can be installed in another room such as the kitchen. It should be additionally appreciated that the floor coverings can be installed at any suitable time such as after the wall and floor framing is complete.

In one embodiment, additional material such as appliances, cabinetry, wall hangings, furniture or other amenities are installed within the factory; however, installation of such additional materials is not required. In one embodiment, raw materials or minor components (e.g. kitchen and bath cabinetry, sinks, showers, tubs, stoves, microwaves, ovens, refrigerators, HVAC units, etc.) for such additional materials are selected and brought from one of the storage areas 102 to the construction assembly location 104. Cabinetry is installed by fixing the material to the walls or floors or in any other suitable manner. In one embodiment, the cabinetry is installed before the floor covering is installed; however, the installation can be in any suitable order. In an embodiment where the desired appliances are installed at the factory, the appliances are preferably secured to the walls or the floors to prevent shifting or damage during transportation of the building from the factory to the building site; however, securing is not required. In a typical house or other building, most appliances are not secured walls or floors. Thus, in one embodiment, custom housing and bracketing materials are used to secure the appliances to a wall and/or a floor. Alternatively, the appliances can be secured to the walls and floors using conventional “L” brackets, screws and bolts, or any other suitably strong securing material.

In one embodiment, the roofing material is installed last; however, roofing material can be installed at any suitable time. Raw material for the roof (e.g., asphalt shingles, plywood decking, roofing felt, slate, wood shakes, steel, roof vents or any other suitable material) is selected and brought from one of the storage areas 102 to the construction assembly location 104. In an alternative embodiment, the roof is designed to be substantially flat and to contain a soil or soil-less medium in which one or more plants are planted; however, the roof is not required to be substantially flat to be planted. Typically, such a roof includes a waterproof layer to prevent water from flowing through the planted layer to the upper level of the building. Further, such a roof typically includes a layer that prevents roots from growing into and damaging one or more other portions of the building. However, the roof can have any suitable configuration. Preferably, the planted roof includes plants native to the location of the building site and further, plants which require little or no maintenance, watering and/or fertilizing, plants which provide habitat for native fauna (e.g., butterflies, birds, lizards, insects, etc.), and/or plants which reduce airborne or precipitation borne pollutants; however the roof can include any suitable plants. Preferably such a roof includes drainage; however, drainage is not required. In one embodiment, the planted roof includes a watering system connected to the building's plumbing and/or electrical systems; however such a watering system is not required or can be connected to its own watering system (e.g., a system in which the water is provided by excess water that drains from the roof and is stored in a barrel, tank, pond or any other suitable storage device for later use) and/or its own electrical system (e.g., a solar and/or wind powered system used to operate a timer and/or pump). As a result of having such a roof, the building's and/or the development including the building can have less of an environmental impact and therefore may experience an easier regulatory approval process if one is necessary for the building to be built and located at the building site (e.g., if the site includes habitat for a protected animal or plant species). Preferably, the roof is not planted; however, the roof can have any suitable design, type and/or configuration. In one embodiment, a decking material such as plywood is attached to the roof trusses; however, any suitable decking material, including no material, can be used. Typically, the next layer attached to the roof is roofing felt or some other water resistant material; however, any suitable alternative to roofing felt can be used as a weather barrier or for any other suitable purpose. In addition, where any roof ridges exit, passive ridge vents can be installed to promote adequate heat dissipation and attic ventilation; however, such vents are not required or can be installed in any suitable location. Alternatively, passive or active roof fans can be installed to aid in heat dissipation and attic ventilation; however neither fans nor any other type of ventilation is required. In one embodiment, the outer most roof layer is asphalt shingles; however the outer most layer of the roof can be slate, wood shakes, steel or any other suitable material. Additionally, gutters can be installed following the roof installation; however gutters can be installed at any suitable time or not at all.

In one embodiment, the layout of a factory used to stick build buildings is dependent on a number of different design factors including among others, the efficiency goals, the manufacturing process, space constraints, equipment constraints, legal constraints and/or any other suitable factors. The two predominate manufacturing processes used for factory production are the assembly point and the assembly line, and the stick-building factory systems of various embodiments can use assembly point, assembly line, a combination or any other suitable manufacturing technique. Using the assembly point technique, a building is stick-built in one place (e.g., construction assembly locations 104) while workers and materials are brought to the assembly point. Using the assembly line technique, materials and/or workers are positioned at predetermined points along a production line while the building under construction is moved through the line to the materials and workers. Within these manufacturing processes, the specific arrangement of materials and equipment can be determined according the efficiency or any other suitable goals. The efficiency goals (e.g., the production rates goals) will typically cause variation in the space and equipment requirements. However space, equipment, and monetary limitations can also dictate the efficiency goals.

Assembly Point Stick-Building Factory

FIG. 1 illustrates a factory with a point assembly layout in accordance with one embodiment. As described above, the factory preferably includes one or more building construction areas 104, one or more raw material storage areas 102, equipment to transport the raw materials to the construction areas, and equipment to move a completed building from the factory to the building's destination. However, the factory is not required to include construction areas, raw material storage areas, or equipment.

In one embodiment, the assembly point manufacturing facility is arranged so that a delivery alley 108 (which may be located inside or outside of the enclosed building 100), the storage areas or bays 102 and the construction bays 104 are parallel to each other; however, the facility can be arranged in any suitable manner. Preferably, the delivery alley is adjacent to the storage areas 102, which are adjacent to and access or queuing area 110, which is adjacent to the construction bays 104; however, the facility can be arranged in any suitable manner.

Further, the factory preferably includes one or more material handling devices (e.g., a fork lift, cranes, conveyor systems, rail systems or any other suitable devices or combination of devices) which are operable to move materials to or from any delivery vehicle (e.g., truck, train, barge, etc.) in the delivery alley 108, the storage areas 102, the access area 110 and/or the construction bay 104; however, the factory can include any suitable device for moving materials between any suitable locations.

Preferably, raw materials and/or minor components for the buildings enter the facility via the delivery alley 108. The delivery alley facilitates delivery of raw material to the material storage 102 and queuing area 110. The material storage 102 and queuing area 110 enables the facility to maintain the proper level of raw materials necessary to efficiently stick-build the home or other building. As described above, the construction bay 104 is used as the final raw material assembly point to stick-build the home. The material handling devices are preferably located throughout the facility and enable the construction crews to shift material from the delivery alley 108 to the material storage 102 and queuing area 110 to the construction bay 104. The substantially completed home is removed from the facility 100 through the exit 106.

In another embodiment, the delivery alley 108 and queuing area 110 are combined. In another embodiment, storage areas 102 and construction bays 104 are arranged around a T formation with an access/delivery area forming the T. Other embodiments have other configurations. In one embodiment having a T formation, the facility has one designated delivery location that is adjacent to the delivery alley (e.g., the bottom of the T). In this embodiment, the delivery trucks make all deliveries at one designated delivery location that can accommodate one or more delivery trucks. The delivered raw materials are then distributed along the delivery alley using smaller material handling devices (e.g., forklifts, dollies, cranes, or any other suitable material handling devices).

In one embodiment, the material storage and queuing areas are separated into distinct material bays according to the materials necessary to build the home. For example, the material storage and queuing area include bays for foundation material, framing material, electrical and mechanical systems material, window material, interior material, and exterior material. Additional material bays may be used depending on the type of raw materials needed. Each bay is also set up to queue the materials needed for one or more current construction projects, in addition to the storage feature in each bay. The queue area is a location in the material storage and queue area that is closer to the construction bay. Raw material is queued because each bay may hold a variety of different building material (such as different brick styles) and every home will not use all of the different varieties of building material kept in the storage bay. Thus, a select quantity and type of material in each bay may be queued for a particular home or other building project. Furthermore, some raw material may require some level of preparation before it can be integrated into the home. Any necessary raw material preparation is preferably performed at the construction bay, however the preparation can be performed while in the queue or before the material reaches the queue or at any other suitable location.

In one embodiment, the foundation material bay stores raw material such as concrete mix, steel reinforcing bars (rebar), cinder blocks, bricks, steel beams, and any other suitable foundation material. The material used for the foundation will depend on the project requirements. In one embodiment, if the foundation requirement calls for a concrete slab, concrete mixture and steel rebars are used. The steel rebars are either fabricated in the storage or queuing area or purchased prefabricated. If required by environmental or other conditions, the steel rebar may have additional processing to resist rust. Preferably, the processing treatments are applied in the construction bay; however, the processing treatments can be applied in the storage or queuing area or any other suitable location. The steel rebar may also be further prepared by cutting the steel rebar to a predetermined size in any suitable location. Likewise, the proper concrete mixture can be brought to the construction bay in a power form. Alternatively, the concrete can also be premixed in any suitable location for immediate use. In another alternative embodiment in which steel beams are used for the foundation, steel beams and welding equipment or riveting equipment are placed in the queue. In the steel beam embodiment, the concrete raw material and steel rebar are preferably not used, so these materials, if any, are left in the storage area of the foundation material bay; however, it should be noted that any suitable materials can be used in various steel beam embodiments.

The framing material bay stores the raw material for framing the home. The framing material may include wood, wood composites, steel, cinderblock, and any other suitable framing material. The material used for the project may incorporate one or more of a combination of the stored framing materials. Thus, one or more of the framing materials can be queued from storage, depending on the construction requirement. As with the foundation material, the framing materials may be purchased prefabricated or materials may be purchased for fabrication at the facility. In one such embodiment using wood, the purchased wood may require further milling because the wood is rough cut or has imperfections. Any additional processing can be performed in the storage area or in the queue area of the framing material bay.

In one embodiment, the electrical and mechanical bay stores raw material for HVAC ducts, electrical wiring, and plumbing. A home or other building may incorporate one or more of the electrical and mechanical materials. As with the material in other bays, the quantity and combination of electrical and mechanical material can be queued to meet the need of the project. Additionally, the materials may be purchased prefabricated or the materials may be purchased for fabrication at the facility.

In another embodiment, the window bay stores the various types of windows used in the home such as double hung, casement, fixed, and any other suitable type of window. As with other material bays, one or more combinations of windows can be queued to meet the need of project. Due to the complexity and necessary precision for window manufacturing, the windows are likely to be purchased prefabricated. However, the windows may be fabricated in the storage or queuing area or any other suitable location if the scale of the project warrants the expense.

In yet another embodiment, the interior bay stores the raw material used for covering the interior walls and floors of the home such as different types of drywall, tiles, wallpaper, drywall compound, tile mortar, carpet, hardwood, and any other suitable interior material. In one embodiment where the construction project requires wallpaper, a predetermined amount of drywall, drywall compound, and wall paper can be queued to meet the need of the project. Similarly, in the same embodiment, the project may require carpeting throughout the home. Thus, full carpet rolls may also be queued along with the wall material.

In one embodiment, the exterior bay stores the raw materials used on the exterior of the home such as brick, aluminum or vinyl siding, fiber cement, wood, shingles, and gutters. As with many homes, the home may require a combination of more than one type of siding material. In one embodiment in which the project requires both brick and vinyl siding, the proper quantity of brick and vinyl siding can be queued to meet the need of the project. Furthermore, as in the case of aluminum gutters, the gutters may be purchased prefabricated or fabricated in the facility. If the gutters are fabricated in the facility, they can be fabricated in the storage area or in the queuing area. In either case, a predetermined quantity of gutters can be queued along with the other exterior siding materials.

In various other embodiments, other bays may include HVAC systems, cabinets, kitchen appliances or any other desired housing material. In various embodiments, some of the bays described above store a variety of material, such as a wide variety of exterior material, where each material may require its own bay. However, in other embodiments, each type of exterior material may be stored in its own bay. In still another embodiment, every type of material stored in the facility will be stored in its own bay.

Preferably, in various embodiments, two or more of the material bays described above are arranged in a sequential format according to when the material will be used in the home construction process. However, it should be appreciated that the material bays may be arranged in any suitable fashion. In at least one embodiment where it is determined that the windows, electrical, and mechanical material can be installed at the same time, these bays can be arraigned with the window bay before the electrical and mechanical bay. Thus, where two or more bays are not dependent on a previous bay, the bays can be arranged in any suitable manner.

Preferably, one or more of the building construction areas 104 are sized and configured to enable a large building (e.g., a multi-storied building; a building having a length and width, the shorter of which is greater than 70 feet; or any other building having dimensions and/or configurations which typically physically or legally prevent the building's intact transportation via public roadways) to be stick-built therein. Further, the construction bays 104 are preferably equipped with storage for one or more tools used to build the building; however, the tools can be placed in a mobile tool cart, carried by workers or made available for use in the construction process in any other suitable manner.

Preferably, one or more building construction areas 104 have an exit door 106, exit area, or any other suitable access arrangement that enables the building to be picked-up or otherwise transported away from the facility; however, such an arrangement is not required. In various embodiments, one or more building construction areas 104 are designed for one or more types of building. In another embodiment, a standard sized building can be built in each bay. Standard sized buildings are generally large single family homes having a square footage of about 1600 ft or larger; however, a standard sized home can be any home that is too large to be legally or physically transported intact via public roads.

The exit doors 106 or areas of the construction bay can have any type of suitable door or no door (e.g., a simple opening). For example, the door can be a garage style door that can be closed to maintain a suitable or desired interior climate and/or protect the building construction from outside or exterior weather, theft or other undesirable elements. Alternatively, the exit 106 can be an opening with no door or covering, sized and configured to allow the building to exit there through.

In one embodiment, the building can be constructed such that the building is substantially complete and in “move-in” condition while still in the enclosed building 100; however, the building can be put in move-in condition at a different building or exterior location at the factory site or at the building site. In one embodiment, the building is in move-in condition when all aspects of the construction process are completed so that once the building is placed at its destination site and utilities are hooked up, the local or HUD building code will allow the building to be occupied. The move-in condition may include some or all cabinetry, some or all of the typical household appliances installed, and having the interior painted or otherwise finished according to the building owner's request or any other suitable specification. Once the building is substantially completed, it can be moved from the factory site to the building site (i.e., the building's substantially permanent location). Alternatively, the substantially complete building can be moved to a temporary storage location before being relocated to the building site. In one embodiment, a building that is not substantially complete is moved out of construction area 104 once the exterior is complete enough that the elements won't damage the building. The incomplete building is finished elsewhere, thus making room for a new building to be started in the now vacant construction area 104.

Assembly Line Stick-Building Factory

FIG. 2 illustrates a stick-building factory system in which buildings are stick-built on an assembly line. The system includes an enclosed building 200; however, the system can include any number, including zero, of enclosed or open buildings. The building 200 includes a delivery alley 202 used for the delivery of materials and components to storage areas 204 in any suitable manner, including those described above; however, the delivery alley 202 can be exterior to the building 200 or can be combined with an access or queuing area 206. Operations within the building 200 are similar to the point-assembly embodiments described above, except instead of a building remaining stationary throughout its construction process, that building progresses along the assembly line in any suitable manner (e.g., on a building moving vehicle, conveyor system, rails, crane, air pressure/hovering system, etc.) to different specialized construction stations 208 at which construction takes place. For example, at one construction station, the foundation or floor frame is constructed. At another, exterior walls are integrated into the building. At still another, interior walls are integrated. At yet another, interior and/or exterior finishing takes place. It should be appreciated that any suitable construction can take place at any suitable construction station 208 and that more than one type of construction can take place at a single construction station 208. Further, it should be appreciated that the enclosed building 200 can include more than one assembly line or intertwined assembly paths. For example, the enclosed building 200 includes three parallel assembly lines 210. The construction stations 208 making up each assembly line 210 can be specific to its assembly line 210; however, it is preferable that two or more of the construction stations 208 in the parallel lines are capable of performing the same construction tasks as construction stations 208 in another assembly line. As a result, if for some reason one construction station is inoperable or is taking longer than expected to complete a construction task, a partly completed house that is ready to progress to the inoperable construction station can move instead to an operable construction station that is capable of performing the same construction task.

Other Factory Building Features

In one embodiment, one or more buildings of the manufacturing factory are substantially permanent structures (e.g., a structure that cannot be easily removed without conventional demolition). As a permanent structure, the manufacturing factory building will preferably have multiple purposes. For example, the manufacturing factory building is initially used for home construction. Later, some or all of the manufacturing equipment and supplies are removed from the manufacturing factory, and the building can then be repurposed for any suitable use (e.g., a community building, a sports facility, a commercial building, single or multiple retail stores, an entertainment facility, etc.). Due to the size of the building in various embodiments, the repurposed facility could house one or more indoor pools, racquetball courts, or any other desirable community related activities.

In an alternative embodiment, one or more buildings of the manufacturing factory are constructed as movable manufacturing factory buildings. After some or all manufacturing operations within the factory related to one factory location stop and some or all of the manufacturing equipment is removed, the building can be deconstructed in an efficient manner and stored for later use or transported to a new location for substantially immediate use. When another development site or at least a new factory location is ready, the manufacturing factory is erected at the new factory location.

In an alternative embodiment, the factory includes an open facility. Some or all of the interior of the open facility is exposed to the exterior environment. For example, an open facility may include exterior walls, but no roof or a substantial opening in the roof. Alternatively, substantial openings may be present in exterior walls of the open facility or one or more exterior walls may be missing entirely. Further, the open facility can include a fence (e.g., a chain link fence) partly or entirely enclosing and/or defining the sides of the open facility. It should be appreciated that the open enclosure can include or be made or formed from any suitable building materials such as metal, wood, fabric, plastic or any other suitable material or combination of materials.

In one embodiment, the factory is located near or adjacent to a development region including the building sites for the buildings made in the factory, such that the buildings can be transported by ground (e.g., via private roads) to the building sites substantially without traveling on public roads; however, such placement of the factory is not required.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A building manufacturing facility comprising:
an enclosed building;
a materials source; and
a construction area within the enclosed building, wherein the construction area is configured to receive materials from the materials source and to enable stick-building of a large building within the enclosed building using the materials, wherein the enclosed building is configured to enable the large building to be moved from the enclosed building to another location.

2. The building manufacturing facility of claim 1, wherein the materials source is within the enclosed building.

3. The building manufacturing facility of claim 1, wherein the materials source is a storage area.

4. The building manufacturing facility of claim 1 further comprising:
a delivery alley, wherein the materials are delivered via the delivery alley to the materials source.

5. The building manufacturing facility of claim 1, wherein the large building has more than one level.

6. The building manufacturing facility of claim 1, wherein the large building cannot be legally transported via public roads.

7. The building manufacturing facility of claim 1, wherein the construction area includes an assembly line.

8. The building manufacturing facility of claim 1, wherein the construction area includes an assembly point at which the large building is substantially completely constructed.

9. A method of building a large building comprising:
receiving materials from a materials source at a construction area within an enclosed building;
stick-building the large building within the enclosed building using the materials, and
transporting the large building substantially intact from the enclosed building to another location.

10. The method of claim 9, wherein the materials source is within the enclosed building.

11. The method of claim 9, wherein the materials source is a storage area.

12. The method of claim 9 further comprising:
delivering the materials to the materials source a delivery alley.

13. The method of claim 9, wherein the large building has more than one level.

14. The method of claim 9, wherein the large building cannot be legally transported via public roads.

15. The method of claim 9, wherein the construction area includes an assembly line.

16. The method of claim 9, wherein the construction area includes an assembly point at which the large building is substantially completely constructed.

17. The method of claim 9, wherein stick-building the large home includes stick-building a planted roof.

18. The method of claim 17, wherein the planted roof includes a watering system connected to the plumbing system of the large building.

19. The method of claim 9, wherein the other location is the large building's substantially permanent building site.

20. The method of claim 9, wherein the other location is a temporary storage location.
